(19) United States
(12) Patent Application Publication
(10) Pub. No.: US 2015/0071732 A1
(43) Pub. Date: Mar. 12, 2015

(54) EYEBOLT

(71) Applicant: YOKE INDUSTRIAL CORP., Taichung (TW)

(72) Inventor: Rong-Der HONG, Taichung (TW)

(73) Assignee: YOKE INDUSTRIAL CORP., Taichung (TW)

(21) Appl. No.: 14/020,052

(22) Filed: Sep. 6, 2013

(51) Int. Cl. F16B 35/06; F16B 45/00

(52) U.S. Cl. CPC F16B 35/06; F16B 45/00
USPC 411/383

(57) ABSTRACT

An eyebolt includes a ring, a pad, and a bolt. The ring has a base member and a ring member connected to a top of the base member. The base member has a first bore, and the pad has a second bore. The pad is received in the first bore of the base member. A thickness of at least a portion of the pad is greater than a depth of the first bore. The bolt has a head and a rod connected to a bottom of the head. A diameter of the head is greater than that of the rod. The rod passes through the first bore and the second bore. Therefore, the eyebolt connects to an object with a threaded hole, and the ring is free to rotate relative to the pad and the bolt.

### BACKGROUND OF THE INVENTION

1. Technical Field

The present invention relates to a connector, and more particularly to an eyebolt.

2. Description of Related Art

In order to replace a mold of a plastic injection molding machine, an eyebolt is screwed into the mold, and then the ring of the eyebolt engages the machine for positioning of the mold. While the eyebolt is tightened, the ring of the eyebolt is fixed in a predetermined angle. Sometime, this angle can't fit the mold to the machine. If loosen the eyebolt to align the mold at the machine, it will disengage the eyebolt with the mold.

U.S. Pat. No. 5,690,457 discloses an eyebolt which provides a bolt to engage the mold, and then a ring is connected to the bolt. The ring is free to rotate relative to the bolt so that the angle of the ring is adjustable without having to loosen the bolt.

However, the ring is pressed by the bolt when the bolt is over-tightened that would make the ring unable to rotate or hard to rotate.

### BRIEF SUMMARY OF THE INVENTION

In view of the above, the primary objective of the present invention is to provide an eyebolt, in which the bolt still is free to rotate even if the bolt is over-tightened.

In order to achieve the objective of the present invention, an eyebolt, which is adapted to connect to an object with a threaded hole, includes a ring, a pad, and a bolt. The ring has a base member and a ring member connected to a top of the base member. The base member has a first bore, and the first bore is communicated with a hollow portion in the ring member. The pad has a second bore, wherein the pad is received in the first bore of the base member; and a thickness of at least a portion of the pad is greater than a depth of the first bore. The bolt has a head and a rod connected to a bottom of the head, wherein a diameter of the head is greater than that of the rod; the rod has a thread; and the rod passes through the first bore and the second bore.

Therefore, the object touches a bottom of the pad, and the head of the bolt touches a top of the pad to screw the rod of the bolt into the thread hole of the object, whereby the ring is free to rotate relative to the pad and the bolt.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is an exploded view of a first preferred embodiment of the present invention;

FIG. 2 is a sectional view of the first preferred embodiment of the present invention;

FIG. 3 is an enlarged view of FIG. 2; and

FIG. 4 is a sectional view of a second preferred embodiment of the present invention.

### DETAILED DESCRIPTION OF THE INVENTION

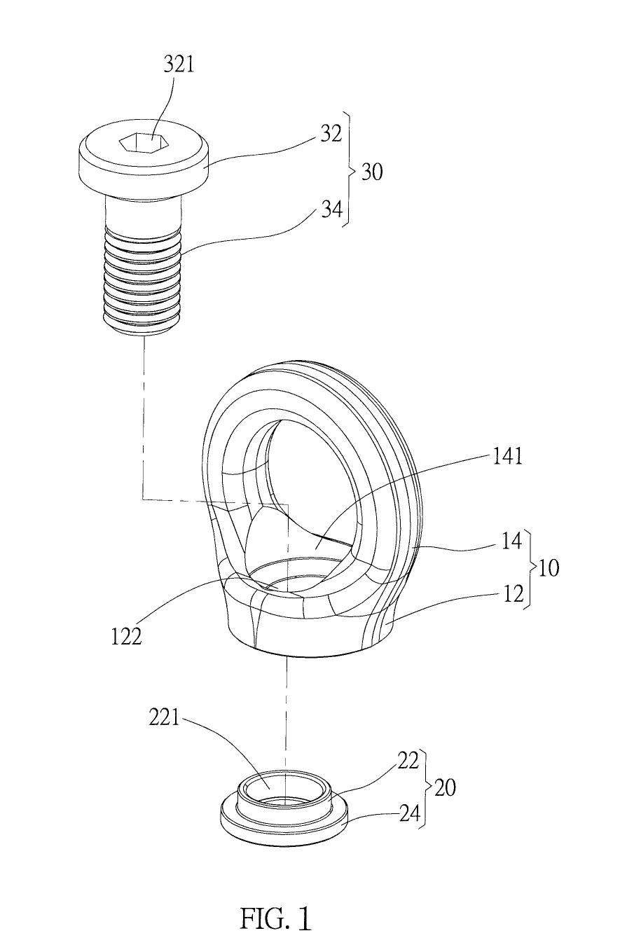

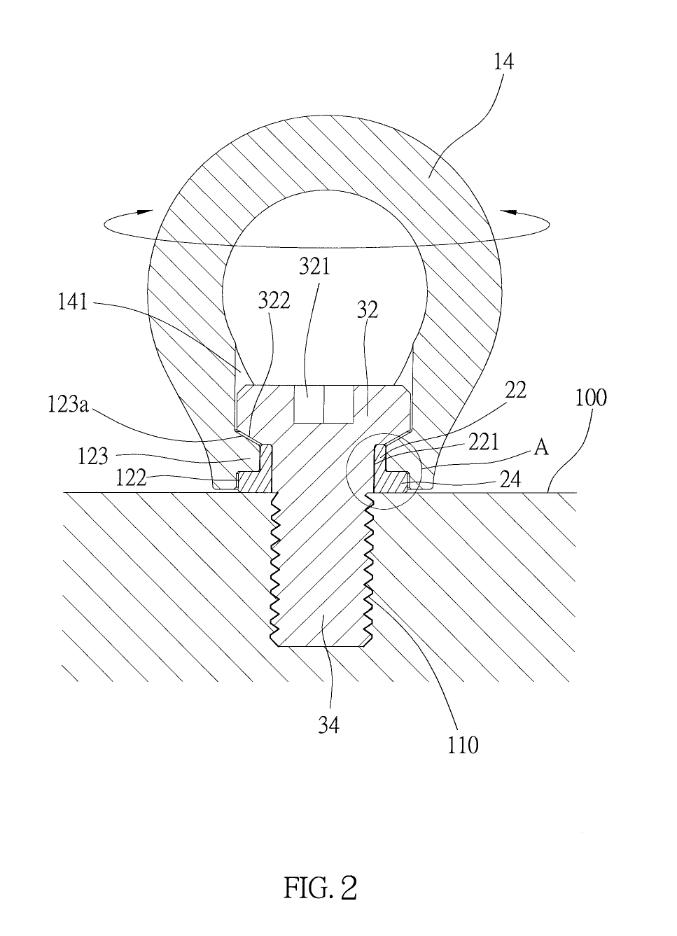

As shown in FIG. 1 and FIG. 2, an eyebolt of the first preferred embodiment of the present invention includes a ring 10, a pad 20, and a bolt 30.

The ring 10 has a base member 12 and a ring member 14 connected to a top of the base member 12. The base member 12 has a first bore 122, which is communicated with a hollow portion in the ring member 14. A receiving space 141 is formed between the first bore 122 and the hollow portion of the ring member 14. An annular protrusion 123 is formed on a sidewall of the first bore 122, and the protrusion 123 has an inclined face 123a. The inclined face 123a faces the receiving space 141 and slopes downwards from an end connected to the sidewall of the first bore 122 to a distal end.

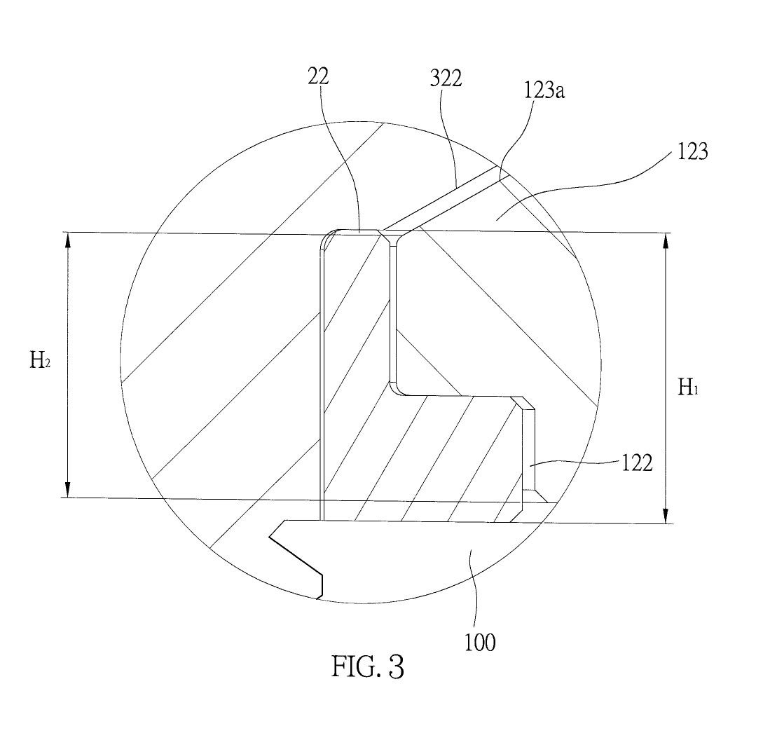

The pad 20 has a resting member 22 and a pad member 24. The resting member has a second bore 221. A diameter of the resting member is slightly smaller than a hollow portion within the protrusion 123. The pad member 24 surrounds the resting member 22. A diameter of the pad member 24 is slightly smaller than the first bore 122. As shown in FIG. 3, a thickness H₁ of the resting member 22 is greater than a depth H₂ of the first bore 122.

The bolt 30 has a head 32 and a rod 34 connected to a center of a bottom of the head 32. The head 32 has a hexagonal recess 321 on a top thereof and an inclined face 322 on the bottom surrounding the rod 34. The inclined face 322 slopes downwards from an edge of the bottom of the head 32 to the rod 34. The inclined face 322 of the bolt 30 matches the inclined face 123a of the protrusion 123. A diameter of the head 32 is greater than the rod 34, and is slightly smaller than the hollow portion of the ring member 14. The rod 34 has a thread.

In assembling, the pad 20 is put in the first bore 122 of the ring 10 via a bottom of the base member 12, and then the rod 34 of the bolt 30 is inserted into the first bore 122 via the top of the base member 12 to rest the inclined face 322 on the inclined face 123a of the protrusion 123. The rod 34 passes through the second bore 221 of the pad 20 and a distal end of the rod 34 extends out of the ring 10 and the pad 20. The resting member 22 of the pad 20 is between the protrusion 123 and the rod 34, and the head 32 is received in the receiving space 141. The protrusion 123 is between the head 32 and the pad member 24. A diameter of the hollow portion of the ring member 14 is greater than that of the head 32 so that the blot 30 is able to be inserted into the first bore 122 without interference. The inclined face 123a of the protrusion 123 has a guiding function to slide rod 34 into the second bore 221 of the pad 20.

One may engage a wrench (not shown) with the hexagonal recess 321 of the bolt 30 to screw the rod 34 into a threaded hole 110 of a mold 100. When the bolt 30 is tightened, the bottom of the head 32 is pressed on the resting member 22 of the pad 20, and a bottom of the pad member 24 is attached to the mold 100. Next, the ring member 14 of the ring 10 engages a machine (not shown) to position the mold 100 to the machine. With the thickness H₁ of the resting member 22 greater than the depth H₂ of the first bore 122 and the inclined faces 123a and 322, it may keep the head 32 and the pad member 24 away from the protrusion 123 respectively to make the ring 10 and the bolt 30 rotate independently. By the eyebolt 10 of the present invention, the ring 10 is free to adjust its angle for positioning the mold 100 to the machine.

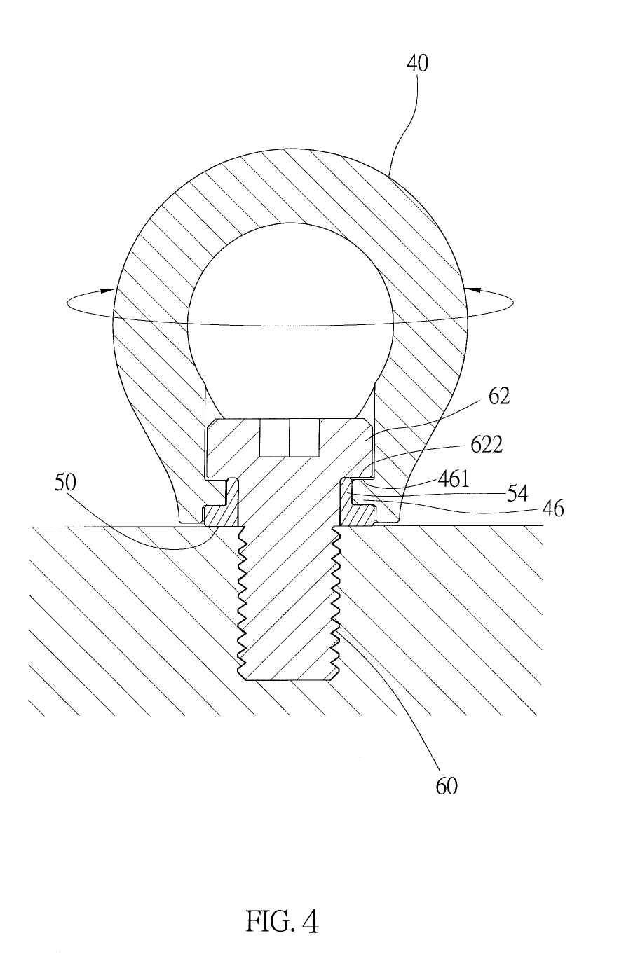

FIG. 4 shows an eyebolt of the second preferred embodiment of the present invention, which is similar to first preferred embodiment, except that a ring 40 has a protrusion 46, and the protrusion 46 has a horizontal face 461 rather than the inclined face. A bolt 60 has a head 62, and the head has a horizontal face 622 accordingly. The stress of the bolt 60 is evenly distributed to a resting portion 54 of a pad 50 to enhance the durability of the eyebolt.

In practice, the eyebolt of the present invention may be connected to anything except the mold and the machine. It must be pointed out that the embodiments described above are only some preferred embodiments of the present invention. All equivalent structures which employ the concepts disclosed in this specification and the appended claims should fall within the scope of the present invention.

What is claimed is:

1. An eyebolt, which is adapted to connect to an object with a threaded hole, comprising:
a ring having a base member and a ring member connected to a top of the base member, wherein the base member has a first bore, and the first bore is communicated with a hollow portion in the ring member;
a pad having a second bore, wherein the pad is received in the first bore of the base member; and a thickness of at least a portion of the pad is greater than a depth of the first bore; and
a bolt having a head and a rod connected to a bottom of the head, wherein a diameter of the head is greater than that of the rod; the rod has a thread; and the rod passes through the first bore and the second bore;
wherein the object touches a bottom of the pad, and the head of the bolt touches a top of the pad to screw the rod of the bolt into the thread hole of the object, whereby the ring is free to rotate relative to the pad and the bolt.

2. The eyebolt of claim 1, wherein the base member of the ring has a protrusion on a sidewall of the first bore; the pad has a resting member and a pad member; the resting member has a thickness which is greater than the depth of the first bore; and the pad member surrounds the resting member.

3. The eyebolt of claim 2, wherein a diameter of a hollow portion within the protrusion is greater than that of the resting member of the pad.

4. The eyebolt of claim 2, wherein a diameter of the first bore is greater than that of the pad member.

5. The eyebolt of claim 1, wherein a diameter of the hollow portion of the ring member is greater than that of the head of the bolt.

6. The eyebolt of claim 2, wherein the protrusion has an inclined face facing the ring member, and the head of the bolt has an inclined face on the bottom accordingly.

7. The eyebolt of claim 6, wherein the inclined face slopes downwards from an end connected to the sidewall of the first to a distal end.

8. The eyebolt of claim 1, wherein the protrusion has a horizontal face facing the ring member, and the head of the bolt has a horizontal face on the bottom accordingly.

9. The eyebolt of claim 1, wherein a receiving space is formed between the first bore and the hollow portion of the ring member; and the head of the bore is received in the receiving space.
